(19) United States
(12) Patent Application Publication
(10) Pub. No.: US 2002/0143508 A1
(43) Pub. Date: Oct. 3, 2002

(54) Predictive algorithmic model

(76) Inventors: David J. Elliott, Wayland, MA (US); Steven A. Lis, Needham, MA (US)

Correspondence Address: IANDIORIO & TESKA, INTELLECTUAL PROPERTY LAW ATTORNEYS, 260 BEAR HILL ROAD, WALTHAM, MA, 02451-1018, US

(21) Appl. No.: 10/042,509

(22) Filed: Jan. 8, 2002

Related U.S. Application Data
(60) Provisional application No. 60/260,279, filed on Jan. 8, 2001.

(51) Int. Cl. G06G 7/48

(52) U.S. Cl. 703/12

(57) ABSTRACT

A predictive modeling algorithm for deriving the outcome of UV photochemical reactions. The model is created in three sections: A parameter input section, a calculation section, and an output section. Input parameters are loaded into the model, calculations are made automatically by the algorithm, and output numbers given which constitute a theoretical test result. The model is adaptable in that it provides for various wavelengths and levels of input energy, a wide variety of reactive chemical components, and many different surface types. An extensive range of photochemical experiments can be modeled with a simple PC-type computer and commercially available software. This predictive model is designed to simulate real reactions as done in a lab, but many times faster and cheaper.

### RELATED APPLICATIONS

This application claims benefit of U.S. Provisional Patent Application Serial No. 60/260,279 filed Jan. 8, 2001 and entitled “PREDICTIVE MODEL FOR PHOTOREACTIVE CLEANING”.

### FIELD OF THE INVENTION

The present invention is related to photochemical processing systems and test programs where many experiments are needed to identify an optimum result. Considerable expense in both time and money is required to fully characterize new technology and new equipment for integrated circuit manufacturing. Process characterization in the semiconductor field requires many people performing tests and analyzing results, as well a significant expense in laboratory and facility usage. A predictive model which emulates the real conditions of the process allows the tests to be run in the computer at a much faster rate and with significantly lower cost. Only recently have computer models of these highly complex reactions been developed.

### BACKGROUND OF THE INVENTION

In the field of semiconductor processing, reaction chambers are used for many process steps, such as etching, cleaning, and deposition. These chambers are generally operated under a vacuum, and are significantly larger than the wafers being processed. Also, prior art reactors for semiconductor processing generally use heat, radio frequency (RF) energy and other means to excite gases. It is only recently that industrial ultraviolet lasers have been available for use as energy sources in integrated circuits (IC) manufacturing equipment.

Recently, a novel, small volume reactor using ultraviolet (UV) light and reactant gas has been introduced in which reactions are confined to a significantly smaller volume. This new reactor has the potential to significantly reduce the time and cost to produce integrated circuits, being much simpler in design and not requiring high vacuum for wafer processing. Since this new reactor concept departs significantly from existing prior art reaction chambers, very little is known about its behavior. This reactor is described in U.S. patent application Ser. No. 09/736,073, and is incorporated in its entirety by reference.

Prior art models, such as the “Virtual Reactor Simulator” from SRI International, Menlo Park, Calif., are designed for much larger and differently shaped prior art reaction chambers that are used widely in the IC industry. The new reactor type for which the subject invention is created is radically different in shape and volume, eliminating the possibility of using existing models.

In order to use this new, low profile, low volume reactor in integrated circuit manufacturing, significant characterization of its operating parameters must be undertaken. Since this can be a very long and expensive process when done in a laboratory, a predictive computer model has been developed to speed up the process of introduction. The predictive model will assist in the identification of an optimum process for a given application. The highly complex processes used in IC manufacturing result in hundreds or thousands of individual processes, all of which require optimization and contain many variables. The cost and time associated with process optimization is significant if done through a large and complex series of tests. Computerized modeling of this process saves significant time and cost and greatly reduces the number of tests required to validate a new process.

Specifically, the combination of laser light and reactive gases or reactive chemicals have only recently been identified as an alternative way to perform the etching, deposition, cleaning steps and possibly other process steps in integrated circuit manufacturing. UV light and reactive gas processing provides an all-dry method of cleaning and treating semiconductor surfaces, and eliminates the need for highly polluting wet chemical cleaning and processing steps. As a result of this new technology, there is an increasing need to factor in the relationship between UV light and a wide variety of process gases. In addition, the new prototype machines that use these processes have many settings for gas velocity, substrate temperature, chamber pressure, UV energy intensity and so on, and there is a need to optimize these settings for a production manufacturing process to be identified.

There are 3 primary problems associated with prior art models.

The first problem relates to the non-relevance of prior art models. In general, prior art models are highly specific to a problem. In other words, prior art models will work for the traditional etch and deposition chambers and tools used in integrated circuit manufacturing, but will not work for the radically different, low profile, low volume scanning plasma reactor chambers referenced previously. New technology brings new equipment designs, and the prior art models simply do not fit.

There exists no model to permit simulations of the experiments with the new technology equipment. Therefore, the need exists to develop a new predictive model to fit the new equipment and chemical processes. In the UV/gas technology systems now emerging for semiconductor use, there are as many as 10 major process parameters that need to be properly set in order to define an optimum process.

The second problem with prior art models is that they are rigid. In other words, they only permit a very narrow range of parameter space to be studied, beyond which the model fails in its ability to simulate a “real world” solution. Prior art models, for example, do not permit the simulation of all the reactive gas chemistries available to run etching and deposition reactions. Further, prior art models are generally restricted to a single type of energy input, such as RF or infrared, but not both. This is an inherent design problem with many existing models, as they were made to solve a very specific problem with a narrow range of variables.

The third problem with prior art models is that they are difficult and expensive to use. Prior art models require highly trained, technically skilled (mathematics, computer science, software) personnel, and further require expenditures in both software and computer time to run. Almost all process related models have this problem, and this is part of the reason why models are not used more frequently, despite the time and money they could potentially save developers in finding an answer to a problem with many variables.

### BRIEF SUMMARY OF THE INVENTION

It is therefore an object of this invention to provide a predictive algorithmic model for the computer simulation of complex processes using ultraviolet light and reactive gases.

It is a further object of this invention to provide a computerized model that is highly relevant to the equipment for which it was designed. In other words, the model will create, in computer space, the exact same conditions as would be experienced in the laboratory, permitting good translation from the model results to the actual laboratory results. If the model does not match the conditions in the lab, it usefulness is greatly reduced. The model of the subject invention has been demonstrated (in the example given in the figures) to correlate with real world testing.

It is a further object of this invention to provide a highly flexible model structure with easily changeable parameters to permit the simulation of a large variety of UV wavelengths, laser pulse energies, gas recipes, pressure, temperature, and many different surface conditions.

It is a further object of this invention to provide such a predictive model that is simple to use, does not require a high level of training in mathematics, software, or computer technology, and will run quickly on standard personal computers using commercially available software.

This invention results from the realization that a predictive model can be written to closely match the adjustments available on an UV/gas surface treatment system. The model can account for process variations and the range of tuning of the knobs on the machine can be easily built into the model for maximum flexibility. Furthermore, the model can be written to operate using commercially available business software available on most personal computers, and can be exercised by persons not having a specialized expertise in mathematical modeling, or computer software.

Since the range of each of the possible reactor conditions are known, the model is set up to coincide with these ranges. If any part of the reactor system changes, the model can be altered to match the equipment. It is this degree of flexibility that makes the model highly practical for characterizing a wide range of possible outcomes.

This model permits the user to run literally hundreds of process recipes with a computer and readily available software, quickly and at low cost. Only the computer-optimized simulated test results are then taken into a lab and run with the real system. This saves considerable time and expense.

This invention features a predictive algorithmic model for simulating photocatalytic reactions including an input section for defining a plurality of variables, a calculation section for calculating a plurality of intermediate values and a plurality of output values, and an output section for providing the plurality of output values of the photocatalytic reactions.

In a preferred embodiment, the plurality of variables include material, wavelength and photocatalytic reaction variables, may include at least a firs laser wavelength, a base fluence value, a fluence increment value, a first gas partial pressure, a partial pressure increment, a total pressure, first and second reactant types, a material absorption coefficient, a material threshold value, a material refractive index, an angle of incidence, and first and second photochemical reaction parameters. The first laser wavelength is preferably in the range of 100 to 400 nm.

The plurality of intermediate values may include first and second optical gas densities, an incident fluence absorbed by gas, a reflected fluence, a total fluence absorbed by gas, a fluence absorbed in material, an ablation depth per pulse, and a photochemical component. The plurality of output values may include a total material removed and a removal efficiency. The photocatalytic reactions are typically ultraviolet catalytic reactions.

### BRIEF DESCRIPTION OF THE DRAWINGS

Other objects, features and advantages will occur to those skilled in the art from the following description of a preferred embodiment and the accompanying drawings, in which:

FIG. 1 is a block flow diagram of the predictive model according to the present invention;

FIG. 2 is a representative print out of the model Input Section of the model of FIG. 1 showing the known parameters loaded into the appropriate boxes;

FIG. 3 is a representative print out of the Calculations Section of the model of FIG. 1 showing the formulas used to calculate the values for the reactions in a given test, the outputs of those formulas in the form of curves, and a label to indicate what is being calculated; and

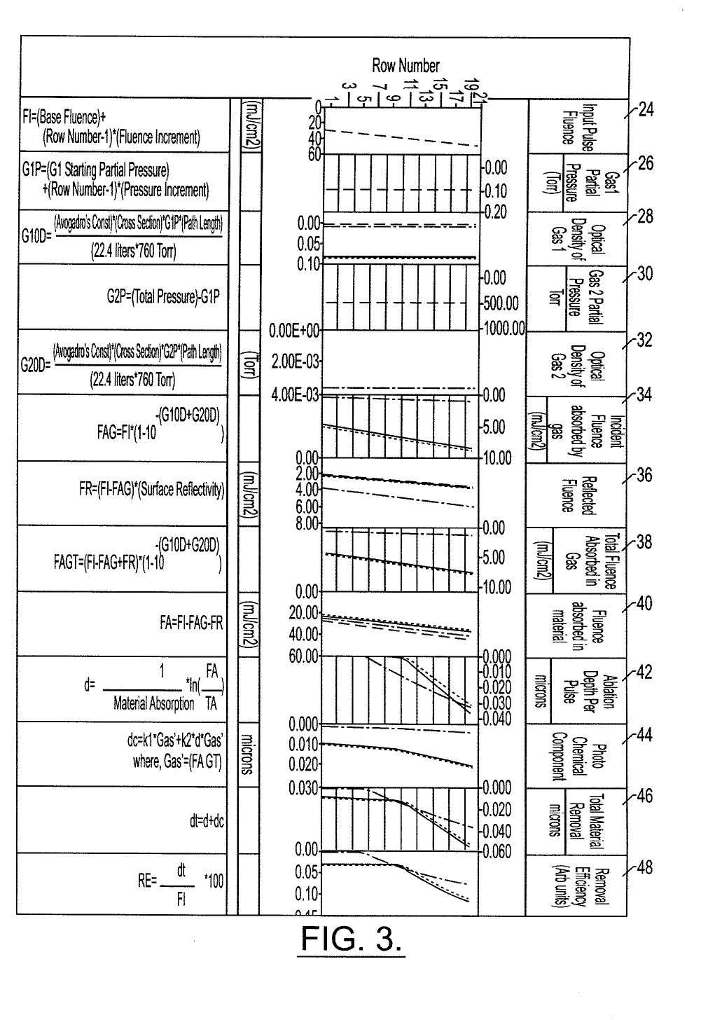

FIG. 4 is a representative print out of the Data Section of the model of FIG. 1 showing the final resultant values.

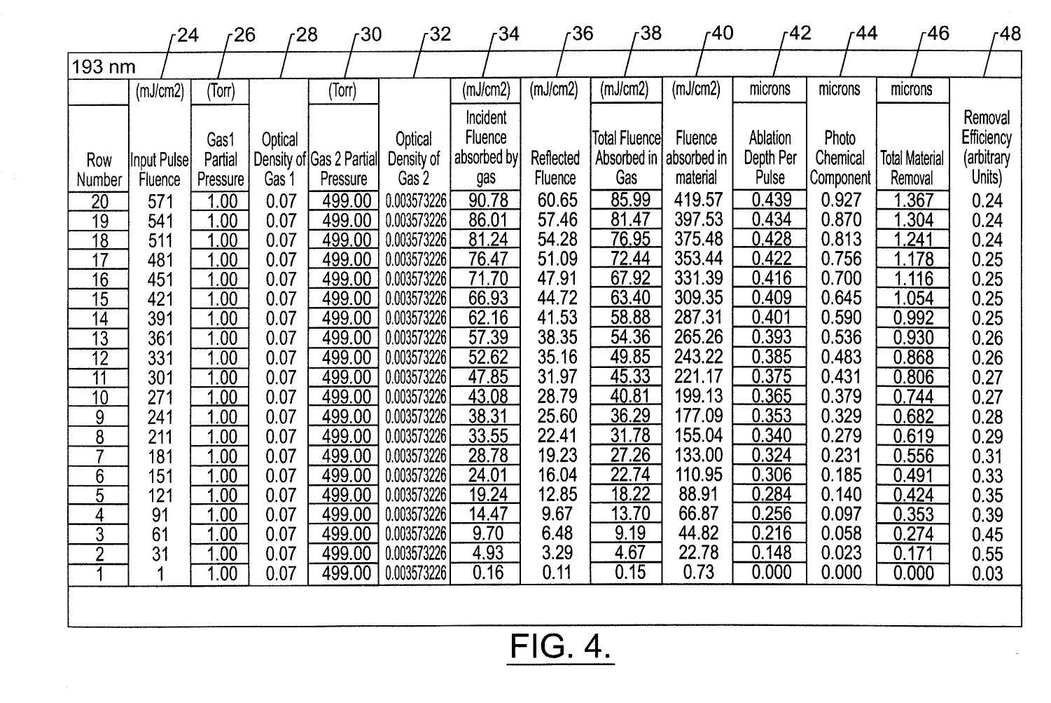

### DISCLOSURE OF THE PREFERRED EMBODIEMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings.

In this preferred embodiment of the model, a UV laser pulse is described as a specified pulse fluence, incident at a specified angle. Portions of the pulse fluence can be absorbed by the gases, reflected from the surface or absorbed by the surface material. A fraction of the fluence is absorbed by the reactive gases, another fraction is then reflected away from the surface of the material to be ablated. The reflected fluence can also be partially absorbed by the gases on the return path. Fluence absorbed in the gases can be used to excite those gases leading to chemical and photochemical removal of surface material. The remaining fluence transmitted into the material can then be used for conventional physical ablation. All the calculations are performed in a stepwise manner, allowing the user of the model the opportunity to observe all the relevant quantities graphically.

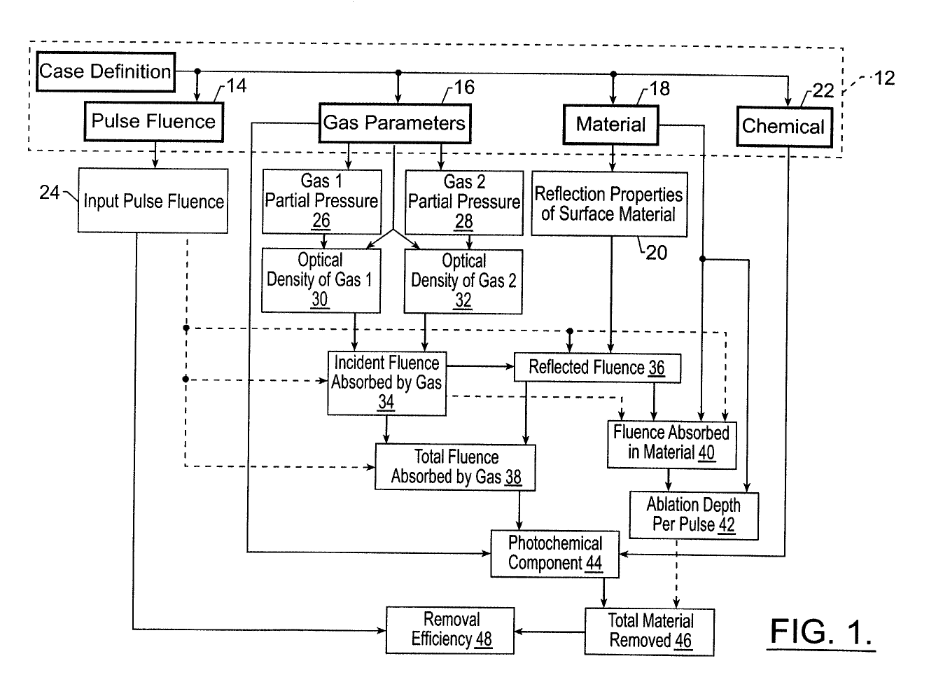

As shown in the flow chart of FIG. 1, the calculations are defined by a number of input parameters specific to the materials, gases, and UV light pulses to be used. Calculations are carried out at each of the laser wavelengths independently because a number of the parameters depend strongly on light wavelength.

The Case Definition or Input Section 12 identifies the materials and laser wavelengths available and defines the principal action of interest on the relevant materials in the process (for example photoresist removal). There are four boxes representing input parameters, many of which are laser wavelength dependent. The Pulse Fluence 14 sets the basis for the range of pulse fluences available to drive the process. The Gas Parameters 16 defines the relevant gas properties, such as optical absorption, and gas concentrations. The Material group 18 defines the relevant properties of the material to be removed from the wafer surface. The Reflection Properties of the Surface Material 20 (within the Material group) are calculated because not all the incident laser energy is absorbed by the material. The Chemical group 22 defines the chemical reaction rate parameters that indicate the magnitude of material removal that is chemically and photochemically influenced.

The Input Pulse Fluence 24 simply sets up a range of pulse fluences available based on the Pulse Fluence 14 parameters. These may be held constant or linearly varied incrementally.

The Gas 1 and Gas 2 Partial Pressures 26, 28 are also set up as a range of gas concentrations available based on the Gas Parameters 16. These may be held constant or linearly varied incrementally.

The Optical Density of Gas 1 and Gas 2 30, 32 are calculated based on the optical properties of the gases at each wavelength and the gas partial pressures indicated.

The Incident Fluence Absorbed by Gas 34 determines the fluence that has been absorbed by both Gases 1 and 2. This absorbed light is available for chemical excitation of the gases, but is not available for ablation of the material on the wafer.

The Reflected Fluence 36 calculates the fraction of light fluence that reaches the surface but is reflected away. This light is also available for chemical excitation of the gases, but is not available for ablation.

The Total Fluence Absorbed by Gas 38 calculates the light absorbed by the gases near the wafer surface. This value will be used to estimate the level of excitation of the gases by the UV light.

The Fluence Absorbed in Material 40 is a measure of how much of the light actually penetrated the material on the surface.

The Ablation Depth Per Pulse 42 uses the absorbed fluence to ablate material based on the absorption coefficient of the material and its ablation threshold. For this model, the pulse duration determines the ablation threshold implicitly. Otherwise it is explicitly assumed that the pulse duration is short enough to be ignored for the processes involved to be assumed instantaneous.

The Photochemical Component 44 combines the excitation of the gases by the light pulse with the presence of the reactive gases directly above the wafer surface to estimate the chemical removal rate of material. It depends strongly on the parameters set in the Chemical group 22.

The Total Material Removed 46 sums the material removed from physical ablation and chemical action to define the total material removed. This quantity can be directly compared with actual test results.

The Removal Efficiency 48 is a quantitative estimate of the material removal rate compared with light fluence. Since the laser light is usually the most expensive ingredient in the process, the material removal rate relative to light availability is a relevant measure of process efficiency.

The model is written in Excel 97™ and is meant to provide a rapid means for the estimation of photochemical ablation rates. They are based on the concept that materials can be removed from the surface of solid materials through the combined action of UV radiation and chemical processes. The model even allows for the potential increase (or decrease) in removal rate through a synergistic linkage of optical and chemical processes.

In the first preferred embodiment one has the opportunity to model the ablation process while varying a single parameter such as Pulse Fluence or Gas Concentration. The introduction of Chemical Activity is accomplished by the introduction of removal rates that depend upon the 1) the concentration of excited gas species 2) by the product of the concentration of excited gas species and the material that was physically ablated and 3) the product of the concentration of gas species and the material that has been physically ablated. (Gas species may become excited by the UV radiation.)

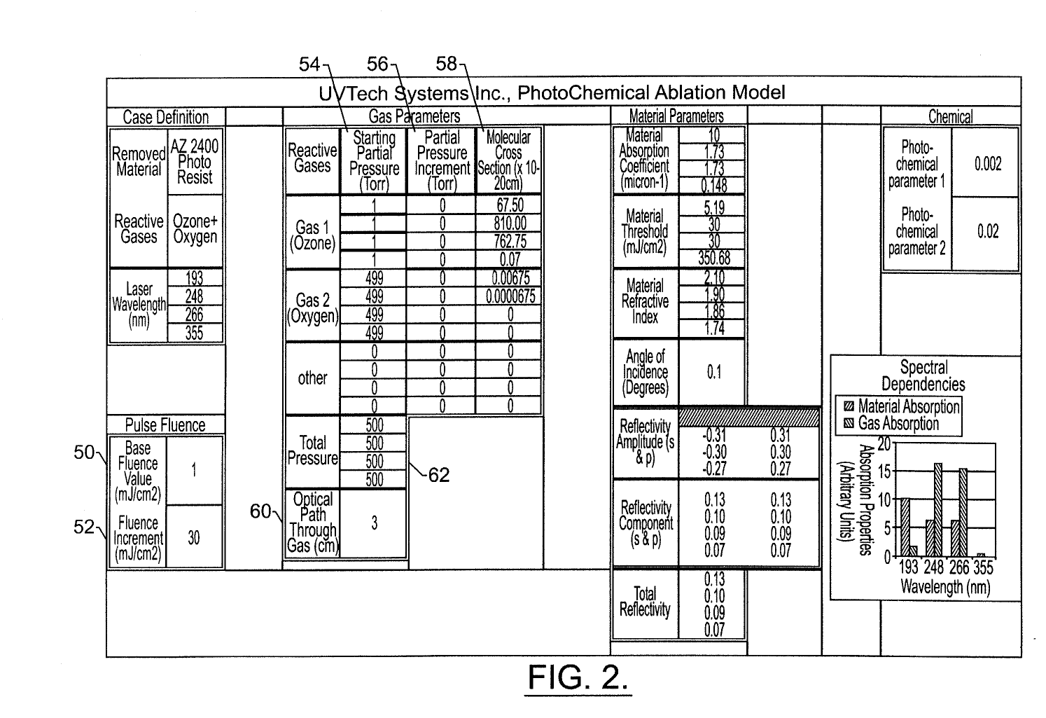

Input Pulse Fluence (FI) 24 is defined in mJ/cm² and as a Base Fluence Value 50, FIG. 2, which is then incremented by the row number (minus 1) times the Fluence Increment 52. This is simply a means for stepping the calculations through a linear range of fluence values. Usually one should start below the ablation threshold and work upwards. Special attention should be paid later on as to whether enough of the fluence reaches the surface or is instead absorbed by the gases.

Gas 1 Partial Pressure (G1P) 26 is defined in Torr and is a Starting Partial Pressure 54 which is then incremented by the row number (minus 1) times the Partial Pressure Increment 56. Like the pulse fluence calculation, this is merely a means of stepping through a range of gas component pressures. Usually one should hold either this partial pressure constant or the fluence constant so that two parameters are not varied at once. In this model it is assumed that the most photoreactive gas component is Gas 1.

Optical Density of Gas 1 (G1OD) 30 is calculated using the Avogadro's constant (A=6.02*10²³), the standard volume of one mole of gas (V=22.4 liters), the molecular cross section (σ) 58 at the specified wavelength, the Gas 1 Partial Pressure (G1P) 26 and the standard atmospheric pressure (760 Torr). This optical density is for a defined optical path length (L) 60 as shown in the equation below:

G1OD=A×σ×G1P×L/(V×760) (1)

This step converts the molecular cross section into a net optical density for the gas. It takes into account the optical path in the gas as well as its density based on the Gas 1 Partial Pressure 26. The increase in the path length related to the angle of incidence can be ignored for angles near vertical incidence.

Gas 2 Partial Pressure (G2P) 28 is calculated by assuming a total base system pressure 62 that is constant. As the Gas 1 content is increased, the Gas 2 Partial Pressure must decrease. This assumes that the system pressure is constant.

Optical Density of Gas 2 (G2OD) 32 is calculated in the same manner as was G1OD 30. The Optical Density of Gas 2 is calculated based on the molecular cross section, optical path in the gas, and gas density as shown in equation (1).

Incident Fluence Absorbed by Gas (FAG) 34 defines the fluence absorbed by the gases as the UV pulse travels towards the surface and is calculated as follows:

FAG=FI×(1−10^{-(G1OD+G2OD)}) (2)

This calculates the loss in fluence as the light pulse makes its first pass towards the surface. It depends only on the optical density of the component gases.

Reflected Fluence (FR) 36 is calculated by using the refractive index (nₜ) of the material to be ablated. The gas is assumed to have a refractive index of approximately 1.0. The reflection is also a function of angle of incidence (θᵢ) (deviation from perpendicular). To simplify matters, this calculation ignores the imaginary component of the refractive index. Ignoring the imaginary component simplifies the calculation, but is not necessary. If the value of the imaginary component is large enough to significantly impact reflectivity, this step can be modified.

$$\begin{matrix}F R = ( F I - F A G ) \times [ \frac{{r}_{⊥}^{2} + {r}_{l l}^{2}}{2} ] \\ where & ( 3 ) \\ {r}_{⊥} = \frac{- sin ( {θ}_{i} - {θ}_{t} )}{sin ( {θ}_{i} + {θ}_{t} )} & ( 4 ) \\ {r}_{l l} = \frac{- tan ( {θ}_{i} - {θ}_{t} )}{tan ( {θ}_{i} + {θ}_{t} )} and & ( 5 ) \\ sin ( θ ) = {n}_{t} \times sin ( θ ) ( Snell ' s Law ) & ( 6 )\end{matrix}$$

The light that reaches the surface is equal to the Input Fluence 24 minus the fluence absorbed by the gas 34 on the way to the surface. The reflectivity of the material on the surface is dependent on the angle of incidence, and the real and imaginary refractive indices for both light polarizations. It is assumed that the polarizations are of equal amplitude and the material thickness can be ignored, i.e., thin film effects are ignored. The calculation could be modified to include partial or total polarization of the optical beam.

Total Fluence Absorbed by Gas (FAGT) 38 represents a measure of the gas absorption in that layer of gas closest to the surface of the material to be removed. This is calculated using the optical densities of the two gases, G1OD 30 and G2OD 32 as well as the input fluence 24 minus the fluence absorbed in the gas 34, added to the reflected fluence 36:

FAGT=(FI−FAG+FR)×(1−10^{-(G1OD+G2OD)}) (7)

This is a measure of the excitation energy available in the gas for chemical reaction. The interest is only on the gas immediately above the surface (within 1 mm). Of the incident light pulse, only that which is not absorbed on the way to the surface can make a difference. Since the optical path (several centimeters) is much larger than the 1 mm of gas we are interested in, the light reaching the surface is an adequate measure of this. Added to this, is the light reflected from the surface. At the moment we assume the material to be removed has the only reflectivity. However, if the material to be removed is sparsely located fine particles and the surface is highly reflective, then FR may be much larger. Then we assess how much of this light affects the gas by taking into account the absorptive properties of the gas.

Fluence Absorbed in the Material (FA) 40 is simply the input fluence (FI) 24 minus the incident fluence absorbed by the gas (FAG) 34, and also minus the reflected fluence (FR) 36. Again it is only the light which actually makes it inside the material to be removed that is of interest.

Ablation Depth Per Pulse (d) 42 is calculated using the material absorption (α) and the ablation threshold (TA) for the material under consideration.

$$d = \frac{1}{α} \times ln [ \frac{F A}{T A} ] \qquad ( 8 )$$

If the amount of ablated material is less than zero it is fixed at zero. This calculation ignores the small path length effect introduced by non-perpendicular incidence. This calculation is based on a simple model for physical ablation. No chemical action is assumed in this step. Only fluences above threshold can remove material, and the removal rate varies as the logarithm of the pulse fluence.

PhotoChemical Component 44 is a complex term that represents chemical mechanisms that might enhance material removal. This term has three removal component mechanisms; (in each case there is a rate constant for removal (kᵢ)

Excited gas concentration k₁×[Gas′] (9)

The product of ablated mass and excited gas concentration k₂×[d]×[Gas′] (10)

The product of ablated mass and gas concentration k₃×[d]×[G1P] (11)

where [Gas′]=(FAGT) (12)

The rate parameters k₁ and k₂ have arbitrary units. The final value is simply the additional ablation depth due to photochemical activity (d_{c}):

d_{c}=k₁×[Gas′]+k₂×[d]×[Gas′]+k₃×[d]×[G1P] (13)

The first component has the ability to remove material even without physical ablation. It only depends on the amount of excited gas directly above the surface.

The second component allows a material removal rate to be defined by a combination of excited gas concentration and ablated material.

In both cases the reaction rate parameters (k₁ and k₂) are very dependent on the chemical species present. They may be somewhat constant across wavelengths and gas concentrations, but should vary significantly between gases and materials.

The third case deals with the idea that after ablation, the debris is hot and can readily react with any gas species present. For simplification, it is assumed that the first gas species is the one which is most reactive due to thermal mechanisms. This may not be true in all cases and can be modified.

These values are not necessarily based on known quantities. The parameters are more likely to be proportionality coefficients only, which are estimated by comparison with experimental results.

Total Material Removal (dₜ) 46 is simply the sum of the ablation depth 42 and the photochemical component 44.

Removal Efficiency (RE) 48 is an arbitrarily defined function that is used to estimate the relation of material removal to the Input Pulse Fluence. It is simply defined as

$$R E = \frac{{d}_{t}}{F I} \times 100. \qquad ( 14 )$$

As a measure of efficiency, we simply ratio total removed material 46 to the input fluence 24. This assumes that our primary goal is to limit the total pulse fluence and achieve the best removal rate.

The model described above is usually exercised through the variation of a single parameter at a time (for example pulse fluence, or gas pressure). However, the model could quite readily allow for the simultaneous variation of two or more parameters and then allow for a visual representation of the results for analysis. Thus the model can be readily expanded to enable multivariant analyses rapidly and efficiently.

The result of the complete model is a test simulator for UV/reactive gas systems wherein many different combinations of test conditions can be tried quickly, results reviewed, more simulations run, until an optimized result is obtained. It is this optimized set of conditions that is taken to the actual laboratory for confirmation.

Because the model presented above includes both photochemical and physical ablation processes, this basis mathematical model can be extended to etching processes that are light enhanced. The Photochemical Component formulae can be readily altered to allow for chemical material removal based on the combination of light absorbed in the material and the chemical reactivity of the gases, whether those gases have been activated by the UV light or not. This would then follow the physical and chemical processes typical observed for photochemical etching.

Furthermore, deposition processes can also be readily modeled, if the parameters which define material removal rates are made negative. Material removal turns into material deposition. One can even model a process where removal competes with deposition.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

What is claimed is:

1. A predictive algorithmic model for simulating photocatalytic reactions comprising:
an input section for defining a plurality of variables;
a calculation section for calculating a plurality of intermediate values and a plurality of output values; and
an output section for providing the plurality of output values of the photocatalytic reactions.

2. The predictive algorithmic model of claim 1 wherein the plurality of variables include material, wavelength and photocatalytic reaction variables.

3. The predictive algorithmic model of claim 1 wherein the plurality of variables include at least a firs laser wavelength , a base fluence value, a fluence increment value, a first gas partial pressure, a partial pressure increment, a total pressure, first and second reactant types, a material absorption coefficient, a material threshold value, a material refractive index, an angle of incidence, and first and second photochemical reaction parameters.

4. The predictive algorithmic model of claim 3 wherein the first laser wavelength is in the range of 100 to 400 nm.

5. The predictive algorithmic model of claim 1 wherein the plurality of intermediate values include first and second optical gas densities, an incident fluence absorbed by gas, a reflected fluence, a total fluence absorbed by gas, a fluence absorbed in material, an ablation depth per pulse, and a photochemical component.

6. The predictive algorithmic model of claim 1 wherein the plurality of output values includes a total material removed and a removal efficiency.

7. The predictive algorithmic model of claim 1 wherein the photocatalytic reactions are ultraviolet catalytic reactions.
